(19) United States
(12) Patent Application Publication
(10) Pub. No.: US 2018/0225620 A1
(43) Pub. Date: Aug. 9, 2018

(54) TASK MANAGEMENT IN RETAIL ENVIRONMENT

(71) Applicant: Wal-Mart Stores, Inc., Bentonville, AR (US)

(72) Inventors: Robert Cantrell, Herndon, VA (US); Donald R. High, Noel, MO (US); Chandrashekar Natarajan, Dublin, CA (US)

(21) Appl. No.: 15/880,574

(22) Filed: Jan. 26, 2018

Related U.S. Application Data
(60) Provisional application No. 62/456,420, filed on Feb. 8, 2017.

(51) Int. Cl. G06Q 10/06; G06Q 10/08

(52) U.S. Cl. CPC G06Q 10/063114; G06Q 10/0633; G06Q 30/0601; G06Q 10/063116; G06Q 10/083; G06Q 10/063112

(57) ABSTRACT

An autonomous supervisor computing system comprises a task facilitator that assigns a plurality of tasks for a combination of human associates and unmanned machines according to a task value assigned to each task of the plurality of tasks; and a data queue that arranges the tasks according to the task values and includes a plurality of records that include data related to at least one of the associates and unmanned machines.

### RELATED APPLICATIONS

This application claims the benefit of U.S. Provisional Patent Application No. 62/456,420 filed Feb. 8, 2017 and entitled “Task Management in Retail Environment”, the contents of which are incorporated herein in their entirety.

### TECHNICAL FIELD

The present inventive concepts relate generally to task management, and more specifically, to management assistance devices, systems, and methods that provide autonomous supervision with respect to store associate task facilitation and monitoring.

### BACKGROUND

Store managers have a responsibility for optimizing available resources, in particular, store employees, contractors, or other associate personnel. This may be challenge since tasks have varying values based on the importance of the task, timing of the task, and consequences arising from failing to complete the task.

Decision-making with respect to assigning workflow tasks to store personnel, generally referred to as associates, may include conventional software tools, but the actual scheduling and timeline of resources for completing an activity rests on a human decision maker such as a store manager. However, such decisions typically include moral and emotional elements, or intuition on the part of the human decision maker, which may result in mismanagement or inefficient allocation of resources to certain workflow tasks.

### SUMMARY

In one aspect, provided is an autonomous supervisor computing system, comprising a task facilitator that assigns a task value to each of a plurality of tasks; at least one sensor device that senses an event that requires a task of the tasks to be performed, wherein the task value is generated as a function of the sensed event; a data queue that arranges the tasks according to the task values and includes a plurality of records that include one or more cognitive value genome inputs that establishes whether the human associates are capable of performing the tasks in view of the sensed event; a matrix processing device that associates the tasks with at least one of the human associates or unmanned machines for capable of performing the tasks; and a monitoring device that monitors the human associates to determine at least one of a location or elements of a physical and psychological condition of the monitored human associates, wherein the one or more cognitive value genome inputs includes a result of the monitoring device.

In some embodiments, the autonomous supervisor computing system further comprises an interrupt processor that changes the arrangement of tasks to be performed in response to a comparison between a current task to a higher priority task.

In some embodiments, the task facilitator modifies the task value as a function of an event modifier that modifies the task value of the task in response to a comparison to similar tasks.

In some embodiments, the tasks include a delivery task which is compared to a different priority task to determine whether the delivery task is to be performed prior to the different priority task or if it is to be performed before the completion of a priority task already underway.

In some embodiments, the task facilitator prioritizes tasks and assigns the human associates and unmanned machines to the prioritized tasks.

In some embodiments, the autonomous supervisor computing system further comprises a management application executed on a mobile device that displays a heat map that provides a graphical representation of data where values cross-references the tasks according to task values; and at least one networked sensory device that populates the heat map with data used to determine the task values, and indicating where tasks need to be performed based on sensors at store items, shelves, or other locations in the store.

In some embodiments, the autonomous supervisor computing system further comprises augmentation device used by the associate to augment work on the task.

In some embodiments, the task facilitator accounts for skills of the associates and a cognitive value genome comprised of preferences, affinities, and talents to assign the tasks.

In another aspect, a system for assisting store managers in assigning tasks to store personnel comprises a management application executed on a mobile device that displays a heat map that provides a graphical representation of data where values cross-references employee tasks and values, which are represented as colors of a display of the mobile device; and at least one internet of things (TOT) or other networked sensor device that populates the heat map with data used to determine the values, and indicating where tasks need to be performed based on sensors at store items, shelves, or other locations in the store.

In some embodiments, the heat map corresponds to a geographic area or a store map.

In some embodiments, the system further comprises a central computer network that understands when the timing and geography of a shopper's online order aligns with the timing and geography of an open associate's slot illustrated at the heat map.

In some embodiments, the combination of the heat map and IOT or other networked sensor permits tasks to be assigned automatically, new tasks to be integrated such as package delivery into the mix of potential store employee tasks.

In some embodiments, the at least one IOT or other networked sensor device senses an event that requires a task of the tasks to be performed, and outputs a signal related to the sensed event to the management application

In some embodiments, the tasks are closed out manually or automatically in response to a result of the sensors.

In some embodiments, the heat map illustrates weighted values and assignments weighted to the skills of store employees.

In some embodiments, the system further comprises a store computer that communicates with either the mobile device or a beacon to determine employee locations in the store.

In some embodiments, the system further comprises an input to the management application that permits data to be manually entered to the management application.

In another aspect, a management tool, comprises a heat map generator that displays a heat map that provides a graphical representation of data where values cross-references employee tasks and values, which are represented as colors of a display of the mobile device; a graphical user interface for displaying the graphical representation at an electronic display; and an input for receiving data regarding an event that requires a task of the tasks to be performed, and used to determine the values, and indicating where tasks need to be performed based on sensors at store items, shelves, or other locations in the store.

In another aspect, a method of task management, comprises assigning a plurality of tasks for a combination of human associates and unmanned machines according to a task value assigned to each task of the plurality of tasks; and arranging the tasks according to the task values and includes a plurality of records that include data related to at least one of the associates and unmanned machines.

In some embodiments, the method further comprises changing the arrangement of tasks to be performed in response to a comparison between a current task to a higher priority task.

### BRIEF DESCRIPTION OF THE DRAWINGS

FIG. 1 is a network diagram of an environment in which embodiments of the present inventive concepts can be practiced.

FIG. 2 is an illustration of an autonomous supervisor computing system prioritizing tasks and assigning associates to those tasks, in accordance with some embodiments.

FIG. 3 is an illustration of a task list heat map displayed at an autonomous supervisor display device, in accordance with some embodiments.

FIG. 4 is a block diagram of an environment in which an operation is performed by an autonomous supervisor computing system, in accordance with some embodiments.

FIG. 5 is a block diagram of an environment in which associate augmentation is performed, in accordance with some embodiments.

FIG. 6 is an organization chart illustrating an arrangement of store associates organized according to tasks in a store environment where embodiments of the present concepts may be practiced.

FIG. 7 is a flow diagram illustrating a task assignment, in accordance with some embodiments.

### DETAILED DESCRIPTION OF EMBODIMENTS

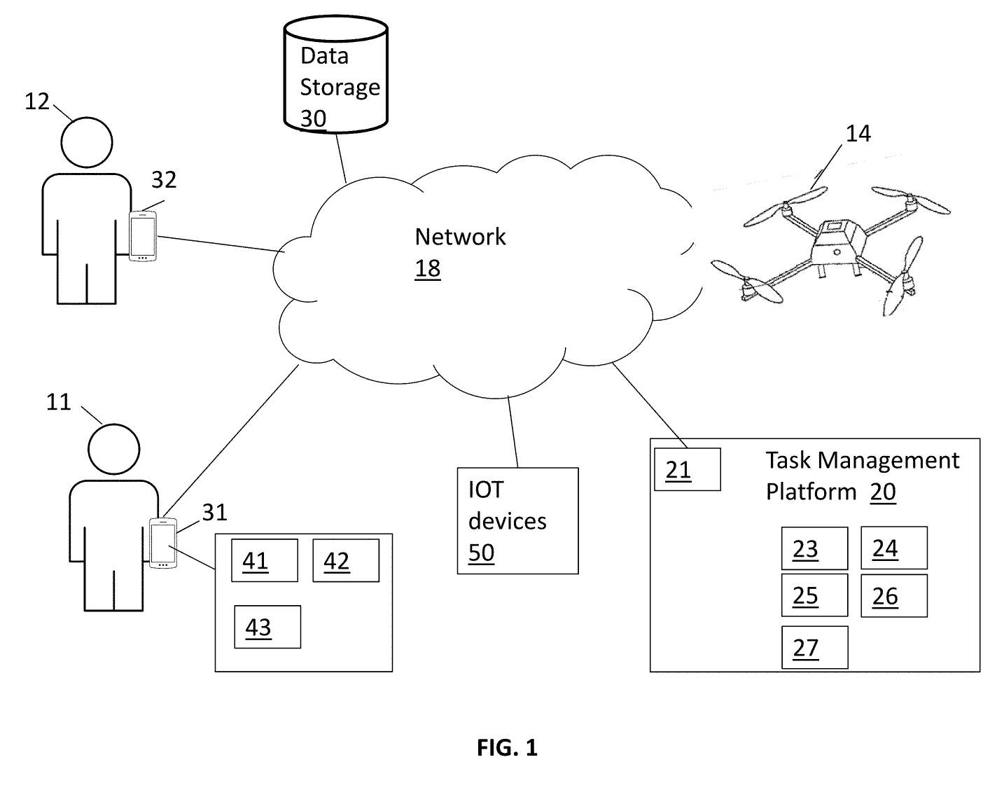

FIG. 1 is a network diagram of a retail environment in which embodiments of the present inventive concepts can be practiced.

The retail environment may include a task management platform 20 and a supervisor mobile computing device 31 at which combined elements of an autonomous supervisor computing system may be stored and executed. The retail environment may also include a store associate mobile computing device 32, a plurality of Internet of Things (IoT) devices 50 and/or other networked sensor devices, and a data storage device 30. The task management platform 20, mobile computing devices 31, 32, IoT devices 50, and data storage device 30 may communicate with each other via an electronic communications network 16. The network 16 may be a local area network (LAN), a wide area network (WAN), wireless network, and/or any other electronic communication exchange environment. In some embodiments, the network 16 includes elements of the Internet. In some embodiments, the network 16 includes a cloud computing system comprising hardware computers, network connectors, and/or other components well-known for processing and storing cloud computing data.

The autonomous supervisor computing system allows a store manager 11 or other person of authority with supervisor responsibility to monitor established tasking decisions, i.e., decisions that have been made, so that the manager is not obligated to make a decision on his or her own. Moral and emotional elements of decision may interfere with effective operations management at a tactical level, while decision making based on intuition may not be effective for handing variable workflows that require fast and accurate comparisons of a task value. A task value is predetermined, for example, set by a store manager on a table based on two important variables: the task itself and the element of time. The task value may have a ranking based on one or more criteria, for example, the purpose, importance, arrival time, consequences of executing a task based on its position in a queue (for example, in data storage device 30), and so on. Variable work flows and the disparate values of workflow tasks mean that store associates 12 may spend part of any given work period performing low-value tasks or no tasks at all, causing the store to lose productivity.

The autonomous supervisor computing system can manage a combined workforce of autonomic machines such as robots, unmanned vehicles such as drones or ground vehicles and people. A store may use robots to perform predictable tasks such as warehouse inventory management, stocking shelves, cleaning aisle floors, and so on. However, humans are better than autonomous systems when performing some tasks. For example, the autonomous supervisor computing system may quickly compute inventory levels as compared to a person, but the person may be better at moving the physical inventory. The autonomous supervisor computing system can assign a store associate 12 a particular task instead of a robot to perform a task without the intervention of a human manager. Further, the autonomous supervisor computing system may monitor associate activity, for example, via wearable devices providing location data on the associate 12, but also elements of their physical or psychological condition. As such, while managing human personnel such as store associates, contractors, or other personnel, the autonomous supervisor computing system may know when to bring the associate water or other necessities because of comparative fatigue or alertness or personality profile, and situations where it may be preferable to assign associate tasks to another associate or robot.

Because the autonomous supervisor computing system functions using pure logic, emotional elements of decision-making are avoided that may lead to inefficient tasking by human managers, for example, personal preferences, biases, human emotion, and so on. However, the system is constructed so that where a given work unit includes both a robotic apparatus and a store associate, the robot may augment the store associate or the human may augment the robot, depending on the task. To achieve this, the autonomous supervisor computing system assigns robots and associates working together to their best-fit roles, to include calculating in assessments of soft variables such as the emotional benefit customers receive when helped in a store by an actual person knowledgeable about the store and the solutions.

The autonomous supervisor computing system may be used for predictable operations that could greatly improve the work environment of associates handling routine tasks over those in traditional management chains. Tasking would be more efficient and performance closely monitored. For example, any time that a manager does not have to spend on issuing tasks to subordinates permits the manager to instead allocate the time to supervising specific tasks, and ensuring that those tasks are performed correctly and/or on time. People at all levels can be free to spend more time than otherwise on the showroom floor with subordinates and customers. Associates could find themselves engaged in more stimulating tasks such as designing aesthetically appealing store layouts, solving larger problems, interacting with customers, or other tasks that require intuitive talents not available by computers.

Autonomous supervisors for stores would be similar in principle to machine-driven management that already exists in military and commercial applications, for example, commercial airplanes with autopilot technology, where the systems can operate with full autonomy but retains pilots for providing a presence during emergencies, or for other tasks that are performed better by a human than a machine. In retail applications, an associate similarly is better at interacting face-to-face with customer than a machine.

Such associate tasking can be broadened or enhanced by using the autonomous supervisor computing system that can see a broader range of parallel activities than a human can. Such tasking may include using on-the-clock associates to fill some delivery tasks when delivery tasks offer higher return/profit to the store than other tasks the associates may perform. Delivery tasks may include but not be limited to loading vehicles, preparing orders for delivery by other people or UAVs, delivering products to customers or delivery hubs, or launching or retrieving fulfillment drones, to the extent that these tasks cannot be better performed autonomously. Such delivery tasks insert a high-value option into the task mix in line with the autonomous store's role to work for customers and can be used as needed to plug in holes in the associate's workday when the system forecasts that associates, at least temporarily, will not be needed for in-store operations. The combination of variable in-store workloads and variable high-value delivery tasks can overall smooth the variance on the minute-by-minute value obtained from associates during a given workday. Smoother workflow variances can be used to save money and lower a store's operating costs. The store can also hire associates needed for in-store operations, and also extra associates who can perform customer product deliveries when not used elsewhere.

To perform the foregoing, elements of the autonomous supervisor computing system may include a task processor 41, a monitoring device 42, and heat map generator 43, which are stored and processed at the supervisor mobile computing device 31. The autonomous supervisor computing system may also include an input/output device 21, a table or matrix processing device 23 that associates human or machine tasks with identified resources, availability, or other status information, a processor 24 for collecting and processing employee cognitive value genome (ECVG) inputs or the like on store associates to determine if they can perform tasks, a task assignment module 25, a heat map manager 26, and/or an artificial intelligence (AI) engine 27, some or all of which are stored and executed at the task management platform 20. The mobile computing device 31 and task management platform 20 each generally comprises a hardware processor, an input device coupled to the processor, an output device coupled to the processor, and memory devices coupled to the processor via a bus or other signal-carrying connector. In some embodiments, the task processor 41, monitoring device 42, heat map generator 43, and task management platform components 21-26 may be co-located under a single platform, or located on different devices.

The autonomous supervisor computing system may include a special purpose data buffer that temporarily stores data on some tasks via a crowd sourcing system to further smoothen variabilities. For example, the crowd-sourcing system to process tasks electronically. Thus, a person who has registered as a crowd-source worker may receive a request to perform a task, which may allow an employee ordinarily performing the task to instead be available to perform different tasks.

The autonomous supervisor computing system performs or allocates task-related functions based on a combination of visual and/or audio feeds, IoT data, time schedules, manual input, identification data, for example, radio frequency (RFID), customer input, logistical data received via the input/output device 21 such as schedules, customer orders, and/or graphical data provided by the heat map manager 26 of the task management platform 20 to the heat map generator 43. In some embodiments, an autonomous tool may determine areas where manual labor is required, for example, a task that involves moving displaced inventory that has fallen out of reach.

The task processor 41 identifies tasks for a combination of human associates and unmanned machines based on a task value equation (see. Eq. 1) that is part of an algorithmic technique hardcoded in an electronic circuit and/or embodied in program code stored and executed by the task assignment module 25 of the task management platform 20.

Eq. 1: Task Value=f ((Assigned Value of Task)*(Event Modifier)−((Assigned Value of Task(n))*(Event Modifier (n))), where n is the most valuable task forgone and event modifier is a function of scale and time. For example, an event modifier could involve orders of magnitude such as the spill of a gallon of orange juice versus a bottle, or it could be location based, such as equivalent spills, one in a back aisle and another near the front door. The tasks each have a value, which may be modified based on time, space, material such as magnitude of the problem, and risk, or a combination thereof. Thus, the task facilitator modifies the task value as a function of an event modifier that may raise or lower or otherwise alter the value of the task when compared to otherwise similar tasks

The monitoring device 42 is configured to monitor the human associates to determine at least one of a location or elements of a physical and psychological condition of the monitored human associates and provides monitoring results to the task processor 41 for facilitating the task results.

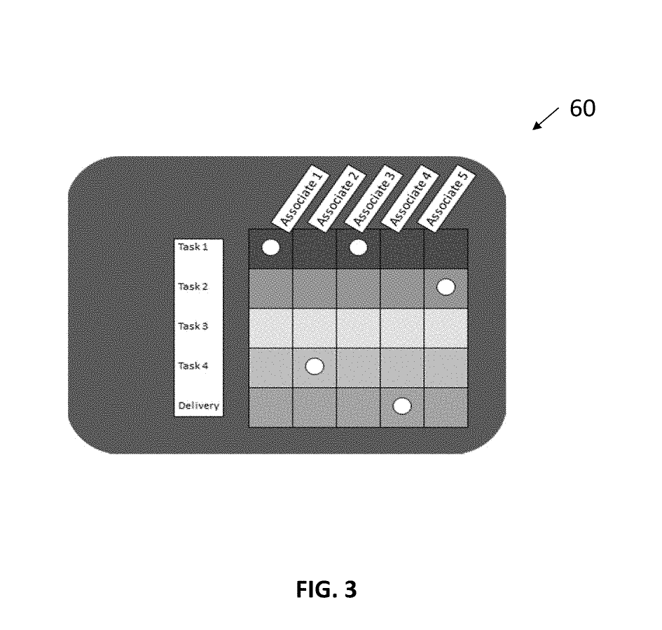

The heat map generator 43 is constructed and arranged to display a task list heat map, for example, shown and described in FIG. 3, by receiving inputs from the heat map manager 26 of the task management platform 20.

The store associate mobile computing device 32 receives task assignments from the autonomous supervisor computing system electronically, more specifically, the task assignment module 25, and without intervention from a human manager, for example, via a smart device, smart glasses, wearable electronic devices, or the like that are part of or otherwise in electronic communication with the mobile computing device 32. Human leadership is known to be proficient at focusing attention on tasks that need to be performed, and less on efficiently carrying out the tasks. The autonomous supervisor computing system can make such operational decisions on behalf of a human manager.

The autonomous supervisor computing system may also reduce inefficiencies of human-assigned work schedules because people may not calculate values and priorities as effectively as computer systems, which can perform purely logical assessments of a task value along with the known capability and availability of associate candidates for performing a particular task.

In some embodiments, the autonomous supervisor computing system may expand the potential tasks available for an associate to include delivering tasks outside a store thereby smoothing the variability of task loads. For example, if a store associate has no higher-value task to perform in-store, then the associate may receive a task assignment, for example, output to the associate mobile computing device 32, to perform a delivery. Thus, store associates may be offered more flexibility with regard to performing tasks, by performing customer support roles such as delivering goods to a customer 14 who purchased the goods online, or from a website. In some embodiments, the task management platform 20 is configured to understand when the timing and geography of an online order of a shopper 14 aligns with the timing and geography of an open associate's slot illustrated at the heat map. The expanded task list to include such tasks may smooth work variabilities that would otherwise allow idle time or for the associate to perform “busy work” or to otherwise spend periods of a work schedule in a non-productive manner.

In some embodiments, the autonomous supervisor computing system may know in advance that an associate may have difficulty assisting a customer. For example, if a sought product has been misplaced and the store associate is not aware, then in some embodiments, the autonomous supervisor computing system can intervene to guide the associate (via communications with the associate mobile device 32) to the misplaced product.

The ECVG processor 24 can allow the system to adapt based on feedback. For example, a drone may “learn” to walk in a similar manner as humans or animals by collecting data, for example, using sensors or the like, on the walking movements of an actual human or animal. The autonomous supervisor computing system, through system neural networks or the like, may collect data on the human performance of tasks that can allow robotic or other automatic elements of the system, for example, drones, AGVs, and so on, to perform ever more complex assignments.

The ECVG processor 24 can complement efficient tasking and monitoring of store associate features of the autonomous supervisor computing system by collecting data on store associates 12 to delivery packages when delivery is a higher value task available over current in-store tasks. Here, a cognitive value genome may be applied to store employees to allow the autonomous supervisor computing system to proactively manage associate conditions and identified needed items such as water, food for sustenance, breaks, and so on before the employee makes such requests. A cognitive value genome may be comprised of preferences, affinities, and talents to assign the tasks. The input of ECVG values may cause the heatmap 60 to dynamically change, since actions, events, or the like related to the task at hand may change.

As described herein, the autonomous supervisor computing system may not perform certain tasks as well as human resources, but can distinguish such tasks from other tasks that the autonomous supervisor computing system may nevertheless perform. For those tasks determined not to be performed by the autonomous supervisor computing system, the task management platform 20 may include a memory that stores prerecorded written, video, and/or audio instructions about how best to perform tasks, which may be output to a personal computing device such as a mobile device 31 or 32. The autonomous supervisor computing system can monitor the pace and quality of work output against expectations of what would be considered a good performance. The autonomous supervisor computing system can communicate other information, such as best practices, to raise the performance of associates.

In some embodiments, the AI engine 27 of the task management system 20 is constructed to match a store associate 12 and an unmanned vehicle 14, such as an AGV, drone or the like. A match may be established based on the skill of the available associate 12 and unmanned vehicle 14 qualified to perform a task. A match may be established based on the closest location of the store associate 12 and unmanned vehicle 14. A list of candidates for performing a task may be established from a match result of both skill and location, or one of skill or location. Either the store associate 12 or unmanned vehicle 14 may reject an assignment. The table 23 may include a state of the store associate 12 and unmanned vehicle 14. In some embodiments, the table 23 maintains a list of activity types of the store associate 12 and/or unmanned vehicle 14 with estimated durations and schedules for entities and activities. Thus, in cases where there are no candidate store associate 12 and/or unmanned vehicle 14, the table 23 may indicate that they are unavailable, and/or other state, for example, active and on duty, available only upon being assigned next based on closest location, and so on. In cases, where the store associate 12 and/or unmanned vehicle 14 accept a task assignment, acceptance of assignment would make the store associate 12 and/or unmanned vehicle 14 no longer available for other assignments or assignments may be stacked when there is no other as store associates 12 and/or unmanned vehicles 14 available or estimated time of completion is short enough to take on more activities in scheduling the store associate 12 and/or unmanned vehicle 14. The store associate 12 and/or unmanned vehicle 14 may be required to acknowledge when a task is complete and available for activities.

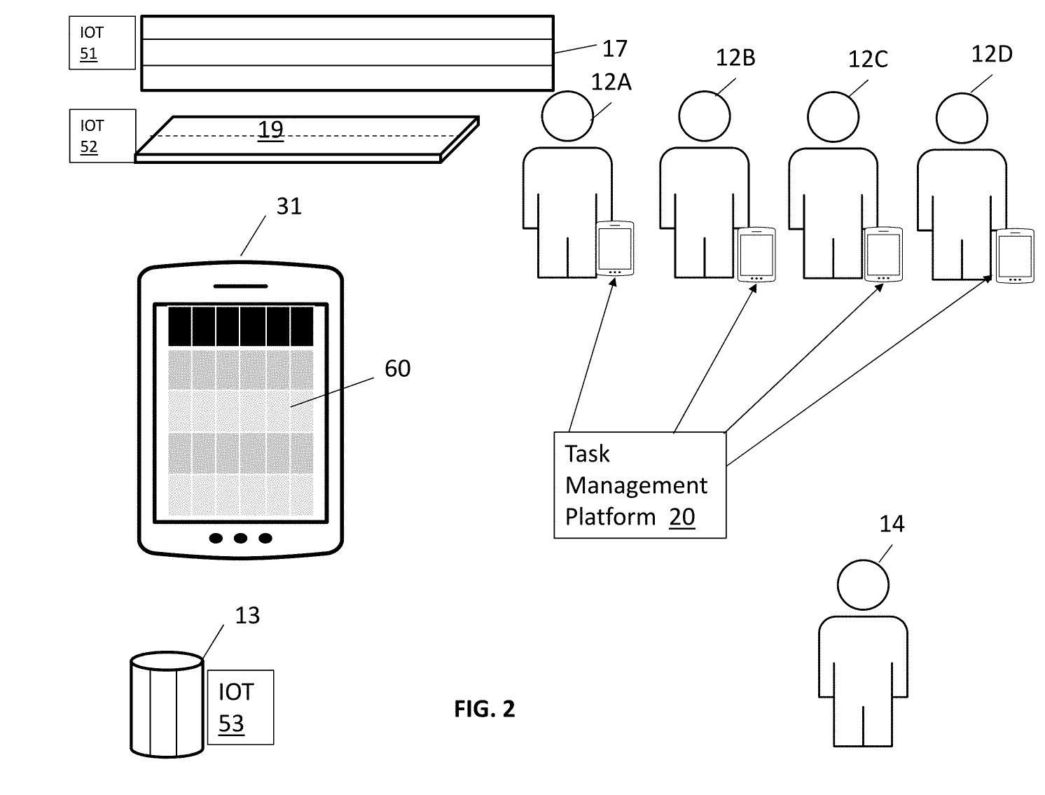

FIG. 2 is an illustration of an autonomous supervisor computing system prioritizing tasks and assigning associates to those tasks, in accordance with some embodiments.

In some embodiments, the autonomous supervisor computing system manages a heat map 60, also shown in FIG. 3, instead of a human manager. For example, a user such as a store manager may populate the tasks with suggestions that will be accepted or rejected, to include automatic acceptance. Here, rather than the manager being required to select and assign an associate, he or she only needs to approve an assignment of a task, therefore permitting the manager to make fewer decisions. The heat map generator 43 may display a heat map 60 that provides a graphical representation of data where values cross-references employee tasks and values, which are represented as colors of a display of the mobile device 31. In some embodiments, the heat map 60 may be shared by managers. For example, a manager of a store operation and a manager of a delivery operation may view the same heat map 60 so that a shared associate for both tasks (store operation and delivery) may be assigned to the task having the highest value, even a task not under the control of either manager, for example a higher authority in the company. The weighted task values displayed in the heat map 60 may be dynamic. Thus, a task of sorting packaged items may rise in value as more packages require sorting (creating more demand), or as deadlines to ship store items approach.

The store environment shown in FIG. 2 includes a plurality of IoT devices 50 shown in FIG. 1, for example, an IoT device 51 at a store shelf 17, an IoT device 52 at a floor aisle, and an IoT device 53 at a trash can 13. An IoT device 50-53 may provide sensor-based computing, for example, including a water meter, event detector, pressure sensor, temperature sensor, video camera, etc, which permit the system to connect physical things or objects together into an Internet of Things (IoT). Physical objects may be managed and controlled in real-time or near real-time. In some instances, a combination of IoT devices and non-IoT sensors may collect data related to a task. For example, an upcoming task may include the stocking of a store shelf 17. Here, an IoT scale 51 may be at the shelf 17, a camera and video analytics device 52 may be at the aisle 19, and/or other devices for producing a 3D point cloud, LIDAR surveying tool, and/or other devices for collecting data used for generating alerts regarding assignment of the task, and so on, or for determining that the task needs to be assigned. For example, a task may include the cleanup of a liquid spill at an aisle. A sensor may establish a magnitude of the spill, which may be input to Eq. 1 above to establish whether an autonomous apparatus or a particular store associate may be assigned to perform the task of cleaning the area having the spill. The autonomous apparatus or a particular store associate may include electronic communication devices to send signals to the system establishing availability to perform the task.

The IOT devices 51-53 may output data used for populating or otherwise providing inputs to generate the heat map 60. In another example, IOT device 53 may include a sensor that establishes that the trash can 13 is approaching capacity, or the IOT device 51 may provide data that a particular item on the shelf 17 is missing. This information may be output to and processed by the input device 21 of the task management platform 20, which in turn updates the table 23 with a task that the trash can 13 needs to be emptied. Other sensors such as a weight sensor, LIDAR, lid pressure sensor, sonic sensor, camera, and so on may also be used.

The heat map generator 43 that display a heat map 60 that provides a graphical representation of data where values cross-references employee tasks and values, which are represented as colors of a display of the mobile device. The heat map 60 may display the tasks according to resource availability, or more specifically, the heat map 60 illustrates weighted task values and assignments weighted to the skills of store employees. The heat map 60 may correspond to a geographic area or a store map. The combination of the heat map 60 and IoT devices 50-53 permits tasks to be assigned automatically, new tasks to be integrated such as package delivery into the mix of potential store employee tasks. The heat map generator 43 may use the listing of resources including a combination of humans and machines and data collected from the IoTs and/or cognitive value genome inputs to update the heat map 60.

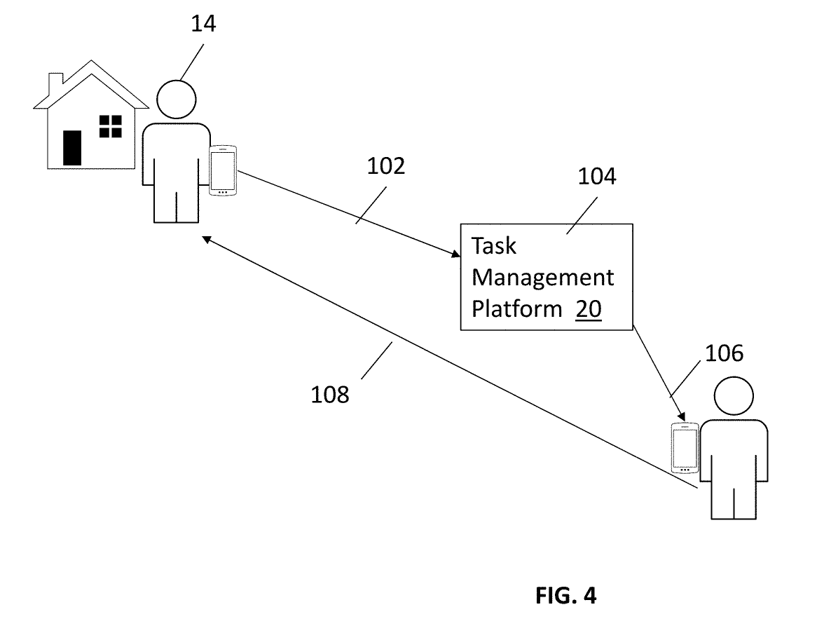

FIG. 4 is a block diagram of an environment in which an operation is performed by an autonomous supervisor computing system, in accordance with some embodiments. In describing FIG. 4, reference is made to FIGS. 1-3.

At step 102, a customer 14 places an order electronically. In addition to the order being received by an e-commerce processor, point of sale system, or the like, the autonomous supervisor computing system, or more specifically, task management platform 20, may receive data related to the order, such as date, time, quantity, and so on.

At step 104, the table processing device 23 associates a task corresponding to the order, for example, a requested delivery instruction, with a set of available resources. The ECVG processor 24 may provide data regarding the ability of the available resources, e.g., store associates, for performing the delivery. A task value may be assigned for each available associate 12A-12D (see FIG. 2). The task assignment module 25 may determine the associate 12 to perform the task based on a combination of the foregoing inputs. A task value comparison may be performed using a table populated with data corresponding to an algorithm in accordance with some embodiments, which compares a task against other tasks in terms of base importance, effects of magnitude, e.g., one broken jar of peanut butter versus ten broken jars, influences of time, space, material, and risk, e.g., a spilled jar of cooking oil in a high or low traffic area, and/or other qualifiers. The resulting score may include a range, with the last element being the order in the queue. The heat map 60 on the supervisor mobile device 31 is displayed to include this new task along with available associates 12A-12D. The heat map 60 can be displayed in a color-coded manner, for example, display red for tasks having a low value, green for tasks having a high value, and so on. As described herein, the task assignment module 25 may be assigned tasks based on importance, so that an associate 12 may perform the most valuable task in the moment, with priority given as displayed by the heat map 60 to finishing tasks already underway before starting new tasks if ample value would be lost stopping and then restarting tasks already underway.

At step 106, a result of the task comparison is processed so that a store associate 12 of the list of identified associates in the table 23 is assigned the task.

At block 108, the assigned store associate 12 carries out the assigned delivery task.

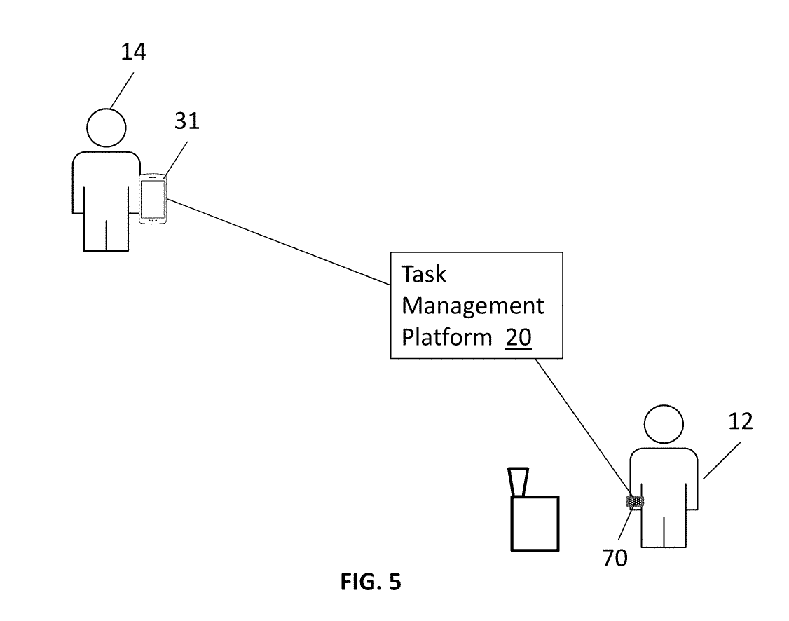

FIG. 5 is a block diagram of an environment in which associate augmentation is performed, in accordance with some embodiments. In describing FIG. 5, reference is made to FIGS. 1-3. A store associate 12 may wear a wearable device 70 that provides information about the store associate, such as location, physical condition using biometrics, and so on. Although a wearable device 70 is shown and described, other apparatuses for automating an employee task-performing efforts may be used, such as Segway™ vehicles, virtual reality glasses such as Google Glass™, so on, or instruction manuals or the like that allow the user to keep pace with robotic apparatuses.

The wearable device 70 may communicate this data to the autonomous supervisor computing system. For example, the wearable device 70 may provide body temperature, pulse rate, sweat levels, and so on which establish that the store associate 12 may need to consume fluids to maintain hydration. In a proactive manner, the supervisor 14 may receive a message, and in response, ensure that the associate 12 receives sufficient water and rest periods needed to ensure that the associate 12 is suited to perform tasks. In another example, the wearable device 70 may monitor brainwaves to establish if the associate 12 is tired, mentally alert, or other physical or biological state. The autonomous supervisor computing system may assign tasks according to the alertness level of the associate 12 based on this information.

Referring again to FIG. 1, the ECVG processor 24 of the task management system 20 is constructed and arranged to process data regarding the physical, physiological, and/or psychological condition of the associate 12, for example, by processing data from sensors on a wearable device 70. This data may be used by the ECVG processor 24 to generate an ECVG profile. The task management system 20 can match personality profiles or the like to the type of work that needs to be performed. The autonomous supervisor computing system uses the ECVG processor 24 to understand how best to gain value from store associates 12 against tasks that need to be performed. This information may be input to the table processing device 23. For example, the autonomous supervisor computing system may account for a combination of known employee skills and the ECVG to assign tasks based on both what needs to be done and who is best suited to perform the tasks. For example, a determination can be made which associates enjoy routine tasks and which enjoy variable challenges.

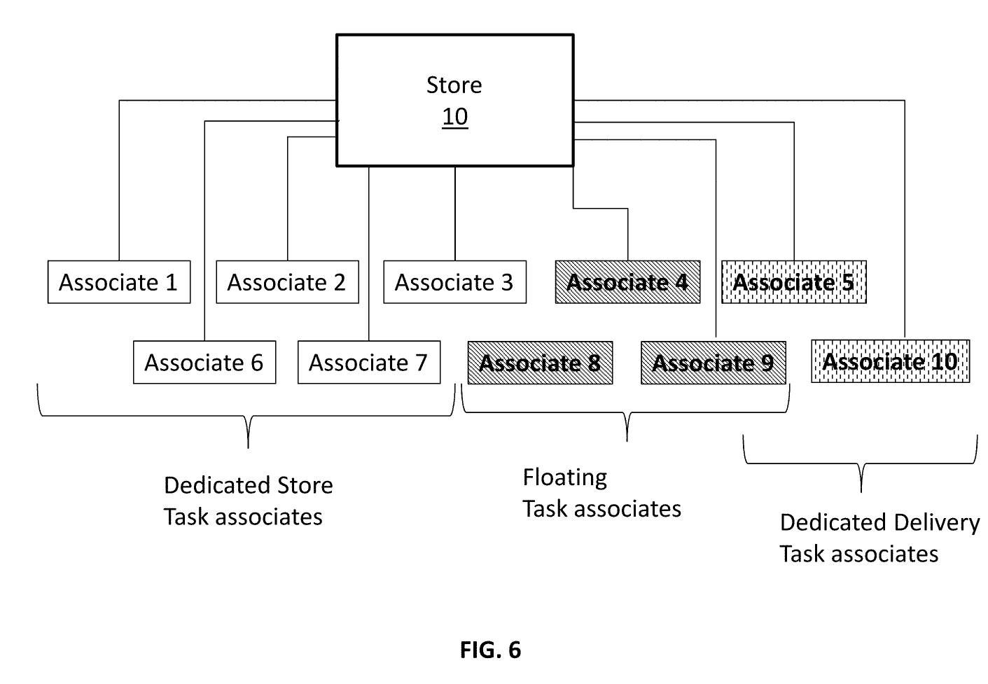

FIG. 6 illustrates a task orientation at a store 10, but placing people into groups, such as dedicated store task associates, floating task associates, and dedicated delivery task associates. The dedicated delivery task associates include store associates assigned to a delivery-related task when delivery is determined to be a high value task by the autonomous supervisor computing system, for example, a highest value task that can be fulfilled for a given time window. A delivery task may be any element of a delivery system such as receiving orders, preparing deliveries, loading vehicles, and performing deliveries. The system may consider the comparative value to the store 10 of assigned tasks along with geographic and traffic information that determines the accepted probability that the associate can make a delivery and return within the given time window.

The autonomous supervisor computing system can optimize associate time by including delivery as a task when the associate may otherwise have down time, or in the case of dedicated delivery associates, involve them in in-store duties if there is a lull in online orders. Dedicating some associates to an in-store shopping experience and others to delivery tasks ensures that competing priorities do not cause one to be met at the expense of others.

The autonomous supervisor computing system may accommodate localization levels within a retail store. Here, the autonomous supervisor computing system may provide a heat map 60 shown in FIG. 3 that includes tasks affected by a location of an active on-duty associate or a UAV/AGV, which may communicate location data with the autonomous supervisor computing system using global position systems (GPS), beacons, UWB, WiFi hotspots, smart LED lights, or other triangulation methods. Other data used to detect a location may include particular activities detected by a sensor, IOT, or the like, and/or scheduled tasks, manager designated, customer requested, and so on. Other factors may establish the heat map contents, for example, product source for delivery, e.g., where the item is on the shelf tracked by inventory compared to store map.

The autonomous supervisor computing system may accommodate localization levels absent a retail store. Here, the autonomous supervisor computing system may provide a heat map 60 shown in FIG. 3 that includes localization levels, such as a delivery location as specified by ordering system from a customer, or a store associate, who may use a smartphone 32 configured with GPS or other location-detection technology.

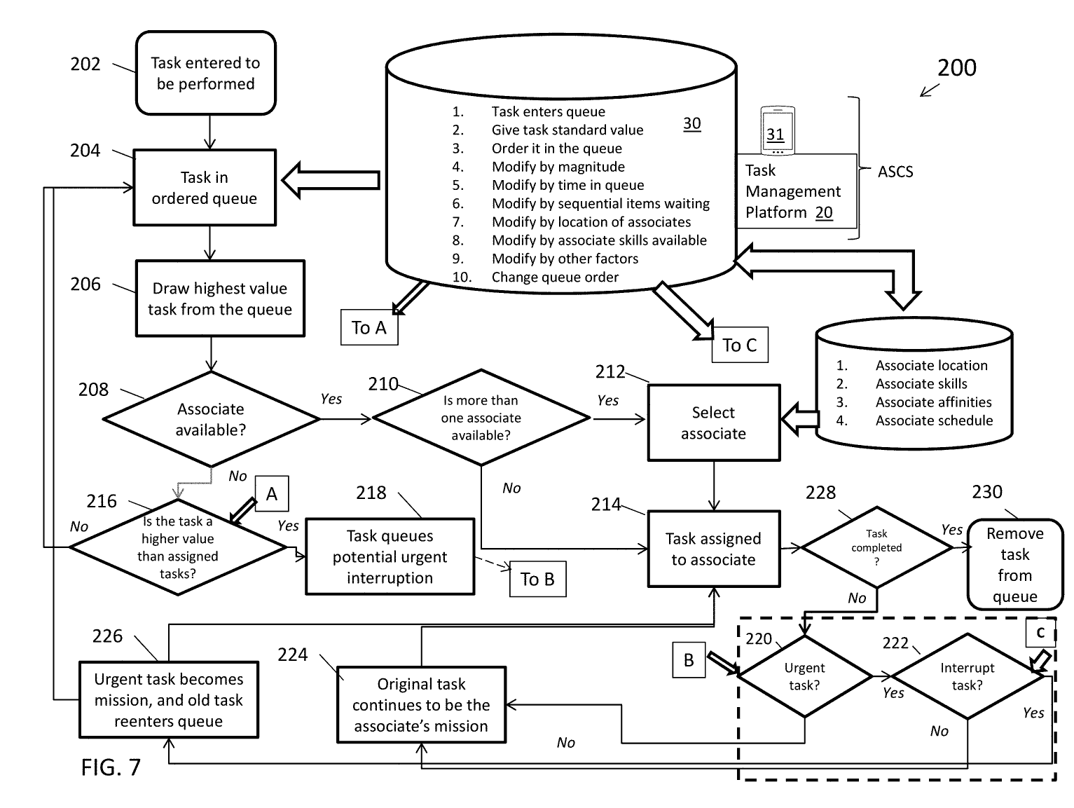

FIG. 7 is a flow diagram illustrating a method 200 of task assignment, in accordance with some embodiments. In describing the method 200, reference may be made to elements of FIGS. 1-6. FIG. 7 illustrates a procedure in which tasks are analyzed, for example, evaluating delivery-related tasks, and addresses and overcomes conventional challenges faced by store managers with respect to deciding whether to assign a delivery-related task to an associate or assign a different task. Although the method 200 refers to the assignment of tasks to associates, tasks can equally be assigned to unmanned machines or other automated apparatuses. A computer evaluates the task is processed, an evaluated against the assets available to perform the task and chooses the best resource available to complete the task. Such tasks may include delivery-related tasks, for example, both an associate and an unmanned vehicle or conventional vehicle such as a manned truck may be used to perform the delivery. Whether to choose the associate would consider the value of other work he might be able to do while the unmanned vehicle, for example, performs the delivery instead of the associate.

At block 202, a task is entered into an autonomous supervisor computing system (ASCS) to be performed.

At block 204, the entered task is assigned a standard value and placed in a data queue (for example, at data storage device 30 of FIG. 1) according to its value. The task value may be modified by the autonomous supervisor computing system (ASCS) according to Eq. 1 above or a different algorithmic technique. As shown in FIG. 7, data may be processed by the ASCS, in particular, task management platform 20 and/or supervisor mobile device 31, whereby the task value may be modified, according to effects of magnitude, time in queue, sequential items waiting, location of associates, and so on.

At block 206, a highest task value is drawn from the queue.

At decision diamond 208, a determination is made whether an associate is available. If yes, then the method 200 proceeds to decision diamond 210, where a determination is made whether multiple associates are available. If yes, then the method 200 proceeds to block 212, where an associate is selected. The associate may be selected according to one or more different factors including availability, expertise, and so on, data of which may likewise be stored at the data storage device 30. At block 214, the selected associate is assigned the task and is assumed ownership of the task. If at decision diamond 210, a determination is made that the associate available at block 208 is the only available associate, then the method 200 proceeds directly to block 214, wherein the associate available at decision diamond 208 is selected and assigned the task.

Returning the decision diamond 208, if a determination is made that an associate is not available to perform the task drawn at block 206, then method 200 proceeds to decision diamond 216, where a determination is made whether the task has a higher task value than one or more other assigned tasks. Here, input may be received by the autonomous supervisor computing system. If yes, then the method 200 proceeds to block 218, where the task queues a potential urgent interruption, or more specifically, the task management system 20 may process an interruption. If at decision diamond 216, a determination is made that the task does not have a higher value than other assigned tasks, then the method 200 process to block 204.

Returning again to decision diamond 216 and block 218, the method 200 proceeds to decision diamond 220, where a determination is made whether a more urgent task, or higher priority task, is identified. If yes, then the method 200 proceeds to decision diamond 222, where a determination is made whether the urgent task at decision diamond 220 is of higher importance than the task identified at block 206. Thus, decision diamonds 220 and 222 collectively involve an interrupt process, and establish two thresholds: whether a task is urgent and whether the urgent task is more urgent than the current task. If at decision diamond 220, a determination is made that a more urgent task has not been identified, of if at decision diamond 222, a determination is made that an identified more urgent task is less urgent and should not replace the original task, then the method 200 proceeds to block 224, where the original task (i.e., the task identified in block 206) continues to be owned by the assigned associate. If at decision diamond 222, a determination is made that the urgent task identified at decision diamond 220 is sufficiently important to replace the original task, then the method 200 proceeds to block 226, where the urgent task replaces the original task, and the original task is reentered into the queue.

Returning to block 214, where a task is assigned to an associate (either the original task, or the more urgent task). The method proceeds to decision diamond 228, where a determination is made whether the task is completed. If yes, then the method 200 proceeds to block 230, where the task is removed from the queue. If no, then the method 200 proceeds to decision diamond 220, where an interrupt process may be performed.

As described herein, some or all of the systems and methods in accordance with some embodiments are implemented in a computer system. The computer system may generally comprise a processor, an input device coupled to the processor, an output device coupled to the processor, and memory devices coupled to the processor via a bus or other signal-carrying connector. The processor may perform computations and control the functions of a computer, including executing instructions included in computer code for the tools and programs capable of implementing a method in the manner prescribed by the embodiments of the figures using the system described with respect to the figures, wherein the instructions of the computer code may be executed by processor via memory device. The computer code may include software or program instructions that may implement one or more algorithms for implementing the systems and methods, as described in detail above. The processor may execute the computer code.

A memory device may include input data. The input data includes any inputs required by the computer code. The output device may display output from the computer code. The memory device may be used as a computer usable storage medium (or program storage device) having a computer readable program embodied therein and/or having other data stored therein, wherein the computer readable program comprises the computer code. Generally, a computer program product (or, alternatively, an article of manufacture) of the computer system may comprise said computer usable storage medium (or said program storage device).

Memory devices include any known computer readable storage medium, including those described in detail below. In one embodiment, cache memory elements of memory devices may provide temporary storage of at least some program code in order to reduce the number of times code must be retrieved from bulk storage while instructions of the computer code are executed. Moreover, similar to processor, memory device may reside at a single physical location, including one or more types of data storage, or be distributed across a plurality of physical systems in various forms. Further, memory device can include data distributed across, for example, a local area network (LAN) or a wide area network (WAN). Further, memory device may include an operating system (not shown) and may include other systems not shown.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to embodiments of the present inventive concepts. Thus, an embodiment of the present invention discloses a process for supporting computer infrastructure, where the process includes providing at least one support service for at least one of integrating, hosting, maintaining and deploying computer-readable code in a computer system including one or more processor(s), wherein the processor(s) carry out instructions contained in the computer code causing the computer system to allow employment and operation of embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method according to embodiments herein. Thus, the present invention discloses a process for supporting, deploying and/or integrating computer infrastructure, integrating, hosting, maintaining, and deploying computer-readable code into the computer system, wherein the code in combination with the computer system is capable of performing a method according to some embodiments.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An autonomous supervisor computing system, comprising:
a task facilitator that assigns a task value to each of a plurality of tasks;
at least one sensor device that senses an event that requires a task of the tasks to be performed, wherein the task value is generated as a function of the sensed event;
a data queue that arranges the tasks according to the task values and includes a plurality of records that include one or more cognitive value genome inputs that establishes whether the human associates are capable of performing the tasks in view of the sensed event;
a matrix processing device that associates the tasks with at least one of the human associates or unmanned machines for capable of performing the tasks; and
a monitoring device that monitors the human associates to determine at least one of a location or elements of a physical and psychological condition of the monitored human associates, wherein the one or more cognitive value genome inputs includes a result of the monitoring device.

2. The autonomous supervisor computing system of claim 1, further comprising an interrupt processor that changes the arrangement of tasks to be performed in response to a comparison between a current task to a higher priority task.

3. The autonomous supervisor computing system of claim 1, wherein the task facilitator modifies the task value as a function of an event modifier that modifies the task value of the task in response to a comparison to similar tasks.

4. The autonomous supervisor computing system of claim 1, wherein the tasks include a delivery task and is compared to a different priority task to determine whether the delivery task is to be performed prior to the different priority task or if it is to be performed before the completion of a priority task already underway.

5. The autonomous supervisor computing device of claim 1, wherein the task facilitator prioritizes tasks and assigns the human associates and unmanned machines to the prioritized tasks.

6. The autonomous supervisor computing device of claim 1, further comprising:
a management application executed on a mobile device that displays a heat map that provides a graphical representation of data where values cross-references the tasks according to task values; and
at least one networked sensory device that populates the heat map with data used to determine the task values, and indicating where tasks need to be performed based on sensors at store items, shelves, or other locations in the store.

7. The autonomous supervisor computing device of claim 1, further comprising an augmentation device used by the associate to augment work on the task.

8. The autonomous supervisor computing device of claim 1, wherein the task facilitator accounts for skills of the associates and a cognitive value genome comprised of preferences, affinities, and talents to assign the tasks.

9. A system for assisting store managers in assigning tasks to store personnel, comprising:
a management application executed on a mobile device that displays a heat map that provides a graphical representation of data where values cross-references employee tasks and values, which are represented as colors of a display of the mobile device; and
at least one internet of things (TOT) or other networked sensor device that populates the heat map with data used to determine the values, and indicating where tasks need to be performed based on sensors at store items, shelves, or other locations in the store.

10. The system of claim 9, wherein the heat map corresponds to a geographic area or a store map.

11. The system of claim 9, further comprising a central computer network that understands when the timing and geography of a shopper's online order aligns with the timing and geography of an open associate's slot illustrated at the heat map.

12. The system of claim 9, wherein the combination of the heat map and at least one IOT or other networked sensor device permits tasks to be assigned automatically and new tasks to be integrated such as package delivery into the mix of potential store employee tasks.

13. The system of claim 9, wherein the at least one IOT or other networked sensor device senses an event that requires a task of the tasks to be performed, and outputs a signal related to the sensed event to the management application

14. The system of claim 9, wherein the tasks are closed out manually or automatically in response to a result of the sensors.

15. The system of claim 9, wherein the heat map illustrates weighted values and assignments weighted to the skills of store employees.

16. The system of claim 9, further comprising a store computer that communicates with either the mobile device or a beacon to determine employee locations in the store.

17. The system of claim 9, further comprising an input to the management application that permits data to be manually entered to the management application.

18. A management tool, comprising:
a heat map generator that displays a heat map that provides a graphical representation of data where values cross-references employee tasks and values, which are represented as colors of a display of the mobile device;
a graphical user interface for displaying the graphical representation at an electronic display; and
an input for receiving data regarding an event that requires a task of the tasks to be performed, and used to determine the values, and indicating where tasks need to be performed based on sensors at store items, shelves, or other locations in the store.
